(19) United States
(12) Patent Application Publication
(10) Pub. No.: US 2010/0205057 A1
(43) Pub. Date: Aug. 12, 2010

(54) PRIVACY-SENSITIVE METHODS, SYSTEMS, AND MEDIA FOR TARGETING ONLINE ADVERTISEMENTS USING BRAND AFFINITY MODELING

(76) Inventors: Rodney Hook, New York, NY (US); Foster John Provost, New York, NY (US); Brian May, New York, NY (US); Brian Dalessandro, Brooklyn, NY (US)

Correspondence Address: Byrne Poh LLP, 11 Broadway, Ste 865, New York, NY, 10004, US

(21) Appl. No.: 12/700,728

(22) Filed: Feb. 5, 2010

Related U.S. Application Data
(60) Provisional application No. 61/150,394, filed on Feb. 6, 2009.
(60) Provisional application No. 61/156,423, filed on Feb. 27, 2009.

(51) Int. Cl. G06Q 30/00; G06Q 99/00; G06Q 50/00

(52) U.S. Cl. 705/14.52

(57) ABSTRACT

Privacy-sensitive methods, systems, and media for targeting online advertisements using brand affinity modeling are provided. In accordance with some embodiments, a method for constructing brand audiences for targeting advertisements is provided, the method comprising: collecting visitation data relating to user-generated micro-content from a plurality of browsers; extracting a quasi-social network from the collected visitation data, wherein the quasi-social network comprises a plurality of links that are induced between the plurality of browsers visiting the user-generated micro-content; selecting seed nodes from the plurality of browsers, wherein the selected seed nodes have performed a brand action relating to the user-generated micro-content that is indicative of brand affinity; determining candidate nodes from the plurality of browsers based at least in part on a distance from the seed nodes in the quasi-social network; calculating a brand proximity score for each of the candidate nodes, wherein the brand proximity score includes one or more brand proximity measures and wherein the brand proximity score is an aggregated distance measurement between the candidate nodes and the seed nodes; generating a ranking of the candidate nodes based on the brand proximity score; and selecting a brand audience for serving an advertisement based on the generated ranking.

### CROSS REFERENCE TO RELATED APPLICATIONS

This application claims the benefit of U.S. Provisional Patent Application No. 61/150,394, filed Feb. 6, 2009 and U.S. Provisional Application No. 61/156,423, filed Feb. 27, 2009, which are hereby incorporated by reference herein in their entireties.

### TECHNICAL FIELD

The disclosed subject matter generally relates to privacy-sensitive methods, systems, and media for targeting online advertisements to users using brand affinity modeling. More particularly, the disclosed subject matter relates to using patterns of relationships between Internet users and online content to create custom segments for media targeting.

### BACKGROUND

Social networking websites, such as MySpace, Friendster, Facebook, and Linkedin, have grown enormously over the past few years. It has been generally reported by industry analysts that as much as forty percent of a consumer's time on the Internet is spent surfing or accessing social networking webpages and/or webpages generally characterized by the core content having been created by other consumers rather than employees of the website being visited. A member of a social networking website establishes an account and creates relationships with other accounts, thereby connecting the members in a network. When a member connects with other members by proffering or accepting invitations to link their pages, those members are broadcasting their own social network. In addition to generating these links of association, members of these social network websites provide descriptive personal profiles that include their likes, their dislikes, demographic information, etc. These personal profiles and links to other members create a social network.

Current approaches for targeting online advertisements generally presuppose that a consumer's visit to a given website(s) reveals his or her interest and therefore the kinds of advertisements that they should be shown. For example, visitors to “www.flyfishing.com” could be assumed to be interested in equipment, clothing and books known to be of interest to fishing enthusiasts. The first generation of Internet advertising companies spent an enormous amount of time and energy creating taxonomies that mapped individual websites such as www.flyfishing.com with categories known to be of interest to advertisers such as travel, sports, education, etc. Many companies, such as Doubleclick Inc., placed cookies on the computers of consumers and used these cookies to target advertisements to consumers based on the interest(s) that had been evidenced by a consumers' visits to a catalogued site.

For a time, this system provided a more efficient way to target consumers for advertisers. Especially in the early years of the Internet when consumers spent the vast majority of their time viewing content produced by the employees of major portals, such as Yahoo! or AOL (formerly America Online, Inc.), it was easy for the creators of advertising technology to state with confidence that a visitor to AOL's “small business” section was a current or would-be entrepreneur who would respond at high rates to advertisements for products, such as franchising opportunities and small business credit cards. However, as consumers began spending an ever increasing percentage of their time on the Internet at social networking websites (and other websites having user-generated content) that defy easy categorization, marketers are increasingly challenged to discern which advertisements can most profitably be shown to which consumers. Whereas in the past, online advertising companies could package consumers for sale to advertisers based on what websites (e.g., sports, travel, beauty, small business, etc.) those consumers visited. It has been currently reported that twenty percent of online consumer page views can be readily catalogued in this manner and that as much as eighty percent of all Internet page views occur on social networking, user generated content and other pages that defy ready characterization into an existing Internet advertising interest segment.

This problem in matching advertisements and consumers has become more acute as the exploding popularity of social networking sites has increased the number of advertisement impressions seen at these sites. It has been reported that social networking websites, such as MySpace, display over one billion advertisements per day. However, a majority of these displayed advertisements are often disregarded by consumers or members of the social networking websites. Even though these social networking websites possess an enormous amount of information on each member and present a number of advertisements per day, advertisers and social networking websites have done little to leverage this wealth of information.

In addition, various approaches attempt to address these problems by leveraging data available from social networking webpages. For example, some approaches derived micro-affinity networks to build custom targeting audiences. However, in some instances, micro-affinity segments can be broad, thereby rendering them close in composition to a general Internet audience sample. As such, generating a desirable lift in media targeting can be difficult.

Accordingly, it is desirable to provide methods, systems, and media that overcome these and other deficiencies of the prior art. For example, privacy-sensitive methods, systems, and media are provided, where audiences are defined without reference to personally identifying information. In another example, privacy-sensitive methods, systems, and media are provided, where audiences are defined as more likely to take brand actions without being induced to by advertising and without displaying advertisements to an audience.

### SUMMARY

In accordance with various embodiments, mechanisms for targeting online advertisements using brand affinity modeling are provided.

In some embodiments, a method for constructing brand audiences for targeting advertisements is provided, the method comprising: collecting visitation data relating to user-generated micro-content from a plurality of browsers; extracting a quasi-social network from the collected visitation data, wherein the quasi-social network comprises a plurality of links that are induced between the plurality of browsers visiting the user-generated micro-content; selecting seed nodes from the plurality of browsers, wherein the selected seed nodes have performed a brand action relating to the user-generated micro-content that is indicative of brand affinity; determining candidate nodes from the plurality of browsers based at least in part on a distance from the seed nodes in the quasi-social network; calculating a brand proximity score for each of the candidate nodes, wherein the brand proximity score includes one or more brand proximity measures and wherein the brand proximity score is an aggregated distance measurement between the candidate nodes and the seed nodes; generating a ranking of the candidate nodes based on the brand proximity score; and selecting a brand audience for serving an advertisement based on the generated ranking.

In accordance with some embodiments, a system for constructing brand audiences for targeting advertisements, the system comprising a processor that: collects visitation data relating to user-generated micro-content from a plurality of browsers; extracts a quasi-social network from the collected visitation data, wherein the quasi-social network comprises a plurality of links that are induced between the plurality of browsers visiting the user-generated micro-content; selects seed nodes from the plurality of browsers, wherein the selected seed nodes have performed a brand action relating to the user-generated micro-content that is indicative of brand affinity; determines candidate nodes from the plurality of browsers based at least in part on a distance from the seed nodes in the quasi-social network; calculates a brand proximity score for each of the candidate nodes, wherein the brand proximity score includes one or more brand proximity measures and wherein the brand proximity score is an aggregated distance measurement between the candidate nodes and the seed nodes; generates a ranking of the candidate nodes based on the brand proximity score; and selects a brand audience for serving an advertisement based on the generated ranking.

In accordance with some embodiments, a non-transitory computer-readable medium containing computer-executable instructions that, when executed by a processor, cause the processor to perform a method for constructing brand audiences for targeting advertisements is provided. The method comprises: collecting visitation data relating to user-generated micro-content from a plurality of browsers; extracting a quasi-social network from the collected visitation data, wherein the quasi-social network comprises a plurality of links that are induced between the plurality of browsers visiting the user-generated micro-content; selecting seed nodes from the plurality of browsers, wherein the selected seed nodes have performed a brand action relating to the user-generated micro-content that is indicative of brand affinity; determining candidate nodes from the plurality of browsers based at least in part on a distance from the seed nodes in the quasi-social network; calculating a brand proximity score for each of the candidate nodes, wherein the brand proximity score includes one or more brand proximity measures and wherein the brand proximity score is an aggregated distance measurement between the candidate nodes and the seed nodes; generating a ranking of the candidate nodes based on the brand proximity score; and selecting a brand audience for serving an advertisement based on the generated ranking.

### BRIEF DESCRIPTION OF THE DRAWINGS

Various objects, features, and advantages of the present invention can be more fully appreciated with reference to the following detailed description of the invention when considered in connection with the following drawing, in which like reference numerals identify like elements.

FIG. 1 is a diagram showing an example of a process for creating brand audiences for targeting advertisements in accordance with some embodiments of the disclosed subject matter.

FIGS. 2 and 3 are examples of bipartite affinity graphs between browsers (e.g., seed nodes and candidate nodes) and user-generated content in accordance with some embodiments of the disclosed subject matter.

FIG. 4 is a diagram showing an example of a process for prediction conversion using social variables in accordance with some embodiments of the disclosed subject matter.

FIG. 5 is a diagram showing an example of a process for evaluating brand audiences by comparing densities of brand actors in accordance with some embodiments of the disclosed subject matter.

FIG. 6 is an illustrative example of a receiver operating Characteristic (ROC) curve that is determined over the network neighbor audience for a brand for the category Airline in accordance with some embodiments of the disclosed subject matter.

FIG. 7 is a diagram showing an example of a process for estimating actual social relationships between browsers in the quasi-social network in accordance with some embodiments of the disclosed subject matter.

FIG. 8 is a schematic diagram of an illustrative system suitable for implementing an application that targets online advertisements using brand affinity modeling in accordance with some embodiments of the disclosed subject matter.

FIG. 9 is a schematic diagram of an illustrative user computer and server as provided, for example, in FIG. 8 in accordance with some embodiments of the disclosed subject matter.

### DETAILED DESCRIPTION

In accordance with various embodiments, privacy-sensitive methods, systems, and media for targeting online advertisements using brand affinity modeling are provided.

Generally speaking, brand affinity modeling is a modeling approach that moves away from click-through-driven targeted marketing. Brand affinity modeling can include, for example, directly modeling the relationship between particular brand actions and particular content and designing a framework for measuring the improvement in brand activity. Moreover, brand affinity modeling can be used to predict which viewers or browsers of an advertisement are likely to subsequently convert. It should be noted that a brand actor is a browser or a user of a web browsing application that takes certain actions indicative of brand affinity, such as, for example, visiting a brand loyalty club page (fan of “X” page), a purchase thank you page, or a company's home page. It should also be noted that micro-content affinity or co-visitation of the same piece of user-generated micro-content leads to brand affinity.

In some embodiments, privacy-sensitive mechanisms are provided that use brand affinity modeling to target advertisements and other media to Internet users. For example, in some embodiments, these mechanisms can be used to extract quasi-social networks from the behavior of one or more browsers (e.g., an anonymous visitor or user) on user-generated content websites or any other suitable user-generated micro-content (e.g., for finding audiences for brand advertising as opposed to direct marketing). In particular, these mechanisms can extract quasi-social networks from data on visitations to social networking pages or other user-generated micro-content. In another example, in some embodiments, these mechanisms can be used to evaluate brand audiences. These mechanisms can also measure brand proximity based on measures of graph proximity, where audiences with high brand proximity show substantially higher brand affinity. For example, based on visitation data to user-generated content, the proximity of a browser to browsers that previously exhibited brand affinity can be quantified. Alternatively or additionally, these mechanisms can collect data for building a content affinity network, determine micro and macro content brand affinity scores, rank browsers, and/or evaluate the efficacy of brand affinity targeting.

It should be noted that collected data, such as visitation data, is anonymous with respect to the browser (e.g., the user and his or her personally identifying information) and content. For example, as described further below, the quasi-social network can be defined without reference to any personally identifying information (PII) (e.g., information, such as name and email address are not linked to an individual user, demographic information, categories of content visited, etc.). In another example, user-posted personal information, such as user-posted personal information in a profile, is not used. In a more particular example, each browser can be represented by a random number and each content page can be represented by a random number. Accordingly, these mechanisms allow the audience to be targeted through normal advertisement network procedures, where an advertisement network informs the advertisement exchange to target the browsers in a given set based on their cookies. Moreover, a user at the advertisement network or any other suitable cannot look up information about particular individual.

As used herein, “user-generated micro-content” generally refers to content (e.g., pages) created by individuals outside the scope of a professional engagement, such as social network pages (e.g., Facebook, MySpace, etc.), pages on a photography website (e.g., Flickr, Google Picasa, etc.), non-professional blogs (e.g., personal weblogs created using Moveable Type, Blogger, WordPress, or Tumblr). For example, micro-content generally includes self-published content or user-generated content, such as content from blogs, content from social networking profile pages on websites, such as MySpace, Facebook, and the like, photograph websites, user commentary (e.g., a blogged comment on a website), non-professional blogs, etc. This is unlike macrocontent, which generally includes professionally published content, such as magazines, newspapers, professional blogs, music websites, news websites, etc.

As also used herein, a “quasi-social network” generally refers to a network or one or more relationships induced among browsers. These browsers can share a substantial content affinity but generally do not know each other.

In some embodiments, these privacy-sensitive mechanisms can also be used to evaluate whether a good brand audience has been selected. For example, these mechanisms can assess a brand audience by comparing the density of brand actors in the identified audience to the baseline density of brand actors in the population as a whole.

In some embodiments, these privacy-sensitive mechanisms can further be used to extract a quasi-social network that embeds a true social network. For example, these mechanisms can determine social-network friends anonymously without collecting or saving any data on browsers' identifies or the content of the pages they visit. In a more particular example, a particular browser can be mapped to a piece of content that is identified as being the browser's online representation. Using this mapping, a quasi-social network can be determined based on visitation data to the browser's online representation. Alternatively, links between browsers in the quasi-social network can be made in response to reciprocal visitation to each browser's online representation. Such a mapping can then used to, for example, target an advertisement and/or any other suitable media to at least a portion of the quasi-social network.

In some embodiments, these privacy-sensitive mechanisms can be used for conversion prediction and for optimizing a marketing campaign. For example, the mechanisms can be used to predict multiple event responses following an advertisement impression. In addition, these mechanisms can include a variable indicating whether or not a browser, following an advertisement impression, performed one or more brand actions or events.

These mechanisms can be used in a variety of applications. For example, using brand affinity modeling, an advertisement network can inform an advertisement exchange to target one or more browsers in an audience based on their cookies, where the advertisement network does not need to save any data relating to the browsers aside from the cookie identifier. In another example, an advertiser or a campaign manager can determine whether a selected brand audience meets a pre-defined set of properties.

The following figures and their accompanying descriptions provide detailed examples of the implementation of the systems and methods of the present invention.

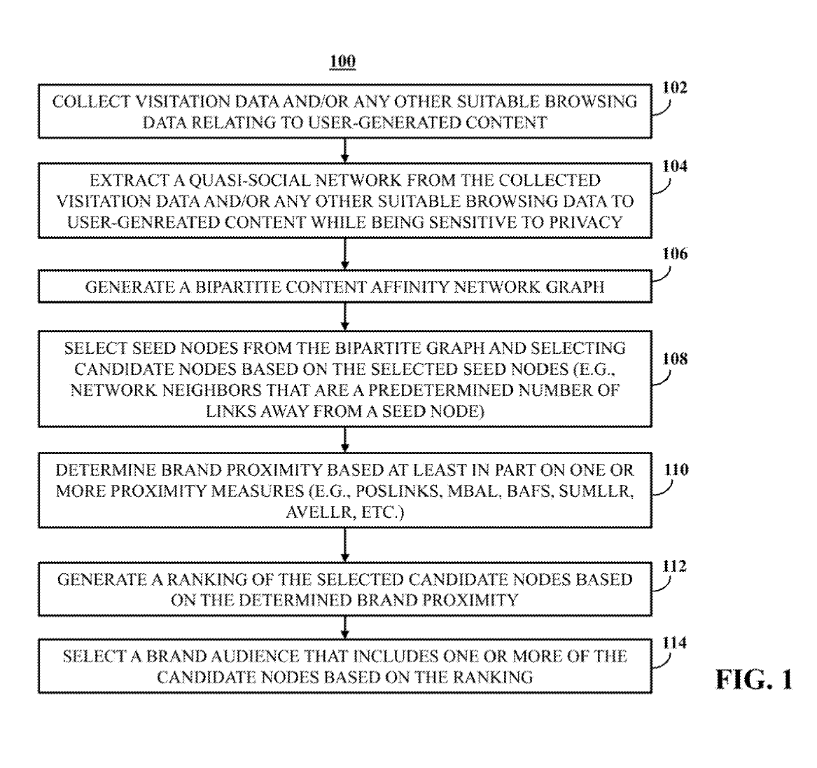

A process for identifying brand advertising audiences in accordance with some embodiments of the disclosed subject matter is illustrated in FIG. 1. As shown, visitation data and/or any other suitable browsing data to user-generated micro-content can be collected at 102. For example, advertising networks serve a large number of advertisements to a large number of browsers and cookies or any other suitable pixel tag can be used to keep track of which browsers visit what content. Each time two browsers visit the same user-generated content page, an affinity network link is placed between the browsers. At 104, a quasi-social network can be extracted from the visitation and browsing data to social networking pages and other user-generated micro-content while being sensitive to privacy.

For example, in some embodiments, cookies, pixel tags, or any other suitable web bugs can be placed on an Internet user's desktop to track unique pieces of Internet content that the Internet browser has visited. These and other features for collecting such data is further described in commonly-owned, commonly-assigned U.S. patent application Ser. No. 12/191,412, filed Aug. 14, 2008, which is hereby incorporated by reference herein in its entirety.

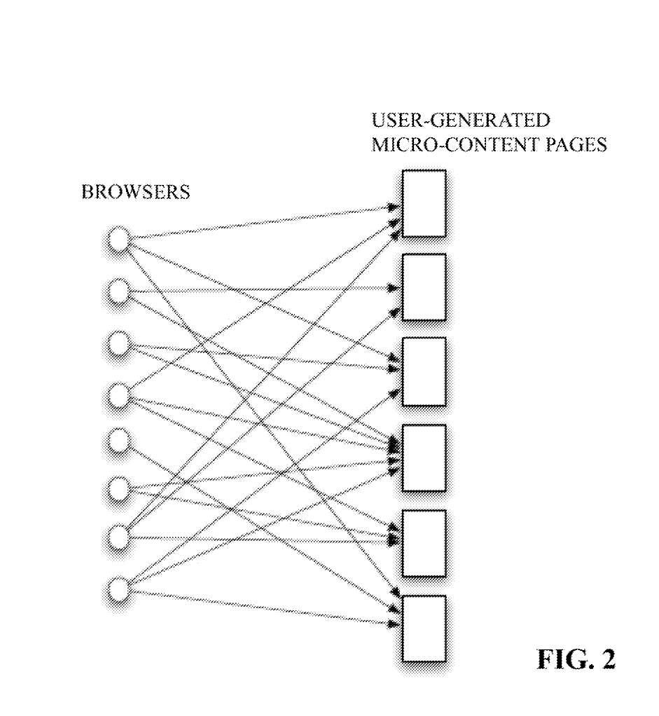

Through the course of time, a browser has a list of unique online content visits in its browsing history. This browsing history can be used to map out relationship between browsers and content. By aggregating the content relationships of the browsers stored in a particular database (e.g., a Media6 database, a database that includes every transmitted cookie, etc.), a bipartite content affinity network that can be used to target online content can be created at 106. From the derived content affinity network, browser-to-browser relationships through consumption of the same or similar content can be mapped out. An example of a bipartite graph representing the mapping between browsers and content is shown in FIG. 2.

It should be noted that the bipartite graphs and/or other graphs described below and the quasi-social network can be defined without reference to personally identifying information (PII). Associations or relationships between browsers and/or any suitable personally identifying information (PII) are not collected. In a more particular example, each browser can be represented by a random number and each content page or piece of content can be represented by a random number. Alternatively, in another example, in order to protect the privacy of users, information relating to micro-affinity groups, database information, personal information, content affinity network groups, or any other suitable personally identifying information is not revealed to the user, members of a user's social network, etc. In yet another example, as the advertisement network does not store data about the browser, an audience can be targeted through normal advertisement network procedures, where an advertisement network informs the advertisement exchange to target the browsers identified by a random number in a given set based on their cookies. Accordingly, audiences can be defined without relying on personal information (e.g., demographic information, psychographic information, personally identifying information) or on the analysis of content that users visit.

At 108, the social network neighbors can be selected from previous brand actors. For example, to assemble a brand audience, a subset of the social network neighbors closest to a set of seed nodes can be selected. Seed nodes are those browsers in the network identified or estimated to exhibit brand affinity or browsers known at the time of audience selection to be brand actors (e.g., existing customers, customers that have purchased a product or a service, customers that have registered a product or a service, customers that have downloaded trial software, consumers who have exhibited interest in the company's product, consumers estimated to belong in a particular demographic or psychographic group, etc.). The subset can be selected by defining a precise type of seed node to use and what it means to be close to the set of seed nodes. It should be noted that defining a seed node can depend on the information available to the advertiser and the advertisement network. For example, seed nodes can represent existing customers, customers having exhibited interest in the company's product, and/or customers estimated to belong to a desired demographic or psychographic group. In a more particular example, the seed nodes are browsers known at the time of audience selection to be brand actors (those browsers observed to have visited a brand-oriented page selected by the advertiser—e.g., a customer login landing page, a purchase thank-you page, a company's homepage).

It should be noted that the building blocks for brand affinity scores are a set of seed nodes, which, in some embodiments, is a set of brand actors, and a subset of all observed content, which is the content that has been consumed by the seed nodes. The subnetwork generated by the seed nodes and their associated content is sometimes described herein as the “Content Landscape.”

After building the content-affinity network, a subset of seed nodes can be selected based on a given criteria. The typical example of seed selection criterion is an observed brand action. As used herein, a brand action can be defined in many ways, but is generally described as an occurrence of a specific interaction between a user and a brand's online presence. Such events may include, for example, visiting a brand's home page, visiting a brand loyalty club page, registering on a brand's website, or purchasing an item via the brand's website. These brand interaction events are typically identified in cooperation with the brand, where the brand implements a pixel on the brand's online properties that can then be used to register a brand interaction event on the browser's cookie. For example, customers or browsers can be identified by visits to a login landing page or to a thank you page.

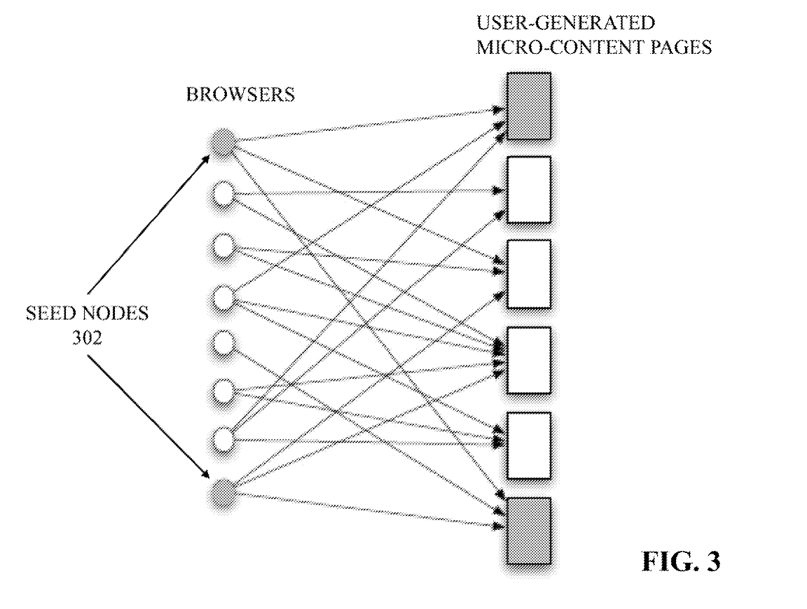

The Content Landscape is embedded in the original landscape and an example of the Content Landscape is shown in FIG. 3. As shown, each node is from the original network, but the seed nodes 302 have been selected and the Content Landscape has been identified (shown as the darkened nodes). It should be noted that the Content Landscape is unique to the set of seed nodes and time frame of observation. Once a set of seed nodes from the content affinity network has been selected, a Content Landscape can be built. The Content Landscape is a subset of individual content ids from the overall set of micro and macro content in the content-affinity bipartite network. In some embodiments, the chosen subset includes all content that has been consumed by at least one of the seed nodes. Accordingly, each Content Landscape is generally unique to the set of seed nodes associated with its genesis. This forms the basis for online media targeting, such that, for each brand, a unique Content Landscape can be generated that offers the brand a unique subset of the content affinity network that can be used to build a micro-affinity network with ranked members.

More particularly, let B represent the total set of M web browsers under consideration and let the seed nodes (B⁺) be a subset of the browsers known at the time to be brand actors (e.g., converters, site visitors, etc.). That is, B⁺⊂B. Accordingly, B⁰=B−B⁺ is the set of browsers not previously observed to have taken a brand action (sometimes referred to herein as “non-seed browsers” or “candidate browsers”).

Referring back to FIG. 1, brand proximity can be determined based on one or more proximity measures at 110. More particularly, based on visitation data to user-generated content, an aggregated distance or similarity measurement between one or more candidate browsers proximity to browsers that previously exhibited brand affinity (seed nodes or browsers) can be quantified. Accordingly, a brand audience of interest A⊂B⁰ can be determined based on browsers' proximity to seed nodes (B⁺) such that a substantial proportion of the browsers in A are likely to be as-of-yet unobserved brand actors.

For example, if there are a total of N user-generated micro-content pages that the browsers have visited. The browsers and the micro-content form a bipartite graph (as shown in FIG. 2). This can be represented by a M×N browser-content matrix as follows:

$$Γ = [ \begin{matrix}{γ}_{11} & … & {γ}_{1 N} \\ ⋮ & ⋱ & ⋮ \\ {γ}_{M 1} & … & {γ}_{MN}\end{matrix} ]$$

In the above-mentioned matrix, each browser bᵢεB is represented by a row in Γ—a content vector \vec{γ}=[γᵢ₁, γᵢ₂, . . . , γ_{iN}]. Each γᵢⱼ represents the weights of the links in the bipartite graph.

In some embodiments, each γᵢⱼ can be a binary value (e.g., a one or a zero) indicating whether browser bᵢ has visited user-generated content page cⱼ and Γ is the biadjacency matrix for the bipartite graph. Alternatively, any suitable metric of relevance to the model can be used for targeting. For example, non-binary weights can also be used. In a more particular example, each γᵢⱼ can be the frequency with which browser bᵢ has visited content cᵢ (visitation frequency) or can count the number of page visits with damping for older counts.

As described above, brand proximity is an aggregated distance or similarity between browser bᵢ (whether a seed node or a candidate node) and its immediate seed node neighbors in the quasi-social network. Brand proximity for a browser bᵢ can be represented by the following vector:

\vec{φ_{b}_{ᵢ}}=[φ_{b}_{₁}¹, φ_{b}_{₁}², . . . , φ_{b}_{₁}^{P}]

where each φ_{b}_{₁}^{P} is one of P different proximity measures. Examples of different proximity measures are described further below.

In some embodiments, a brand proximity measure can be determined by calculating the number of unique user-generated content pages or pieces that link bᵢ⁰ and any seed node bₖ⁺εB⁺ (sometimes referred to herein as “PosLinks” or “POSCNT”). This can be represented as follows:

$$PosLinks ( {b}_{i}^{0} ) = \vert {C}_{{b}_{i}^{0}} ⋂ ( {⋃}_{{b}_{k}^{+} ∈ {B}^{+}} {C}_{{b}_{k}^{+}} ) \vert ,$$

where C_{b}_{ᵢ} is the set of user-generated content (e.g., the one or more pages of user-generated content) visited by browser b₁.

In some embodiments, a brand proximity measure can be determined by calculating the maximum number of unique user-generated content pages or pieces through which paths in the bipartite graph connect a candidate browser to any single seed browser (sometimes referred to herein as “maximum brand actor linkage,” “MBAL,” or “MATL”). This can be represented as follows:

$$M B A L ( {b}_{i}^{0} ) = {max}_{{b}_{k}^{+} ∈ {B}^{+}} ( \vert {C}_{{b}_{i}^{0}} ⋂ {C}_{{b}_{k}^{+}} \vert )$$

In some embodiments, a brand proximity measure can be determined by calculating the minimum Euclidian distance between the normalized content vector of a candidate node and that of any seed node. In a more particular example, for browser bᵢ, let γₜₒₜ be the sum of weights across all content pieces that bᵢ is linked to. That is:

γₜₒₜ=Σⱼ₌₁^{N}γ_{i,j}

The normalized content vector of bᵢ can be represented as:

$${\vec{γ}}_{i}^{n} = \frac{1}{{γ}_{tot}} [ {γ}_{i 1} , {γ}_{i 2} , … , {γ}_{iN} ]$$

The Euclidian distance between a candidate node bᵢ⁰ and a seed node bₖ⁺ can be calculated by:

EUD(bᵢ⁰,bₖ⁺)=∥\vec{γ}ᵢⁿ−\vec{γ}ₖⁿ∥

Accordingly, the minimum Euclidian distance proximity measure for a candidate node bᵢ⁰ can be calculated by:

$$min EUD ( {b}_{i}^{0} ) = {min}_{{b}_{k}^{+} ∈ {B}^{+}} ( EUD ( {b}_{i}^{0} , {b}_{k}^{+} ) )$$

In some embodiments, a brand proximity measure can be determined by calculating the maximum cosine similarity of the content vector of a candidate node and that of any seed node. The cosine similarity between a candidate node bᵢ⁰ and a seed node bₖ⁺ can be represented by:

$$COS ( {b}_{i}^{0} , {b}_{k}^{+} ) = \frac{{\vec{γ}}_{i} \cdot {\vec{γ}}_{k}^{′}}{‖ {\vec{γ}}_{i} ‖ ‖ {\vec{γ}}_{k} ‖}$$

Accordingly, the maximum cosine similarity proximity measure for a candidate node bᵢ⁰ can be calculated by:

$$max COS ( {b}_{i}^{0} ) = {max}_{{b}_{k}^{+} ∈ {B}^{+}} ( COS ( {b}_{i}^{0} , {b}_{k}^{+} ) )$$

In some embodiments, a brand proximity measure can be determined by calculating the ratio of the number of a browser's network neighbors that are seed nodes to the number of non-seed-node neighbors. If deg⁺(bᵢ) and deg⁰(bᵢ) represent the number of links incident to bᵢ from seed nodes and candidate nodes, the ratio of the number of seed-node neighbors to non-seed-node neighbors can be represented by:

$$ATODD ( {b}_{i}^{0} ) = \frac{{deg}^{+} ( {b}_{i} )}{{deg}^{0} ( {b}_{i} )}$$

In some embodiments, a brand proximity measure can be determined by calculating a brand actor friend score (BAFS) that estimates whether a seed node has actually visited the user-generated content generated by bᵢ⁰. It should be noted that users of user-generated content often visit their own user-generated content and, inter alia, their friends' user-generated content. Based on Γ, it is estimated which user-generated content page is most likely to be authored by each browser. A specific page visited often by a browser, but not often by the general population, is the page most likely to correspond to a browser's own page (e.g., his or her own social network page, photo-sharing page, blog, etc.).

It can be estimated that the user-generated content page visited most by a browser, normalized by the overall popularity of the content, is owned by the browser. This page can be called browser bᵢ's home page. The social variable or proximity measure BAFS represents the log-likelihood of a positive brand actor visiting this home page.

Let the ownership likelihood function Lᵢ(cⱼ) represent the likelihood of user-generated content page cⱼ being owned by browser bᵢ. The page that maximizes the likelihood estimate can be represented by:

$${c}_{{b}_{i}}^{*} = {arg max}_{{c}_{j} ∈ {c}_{{b}_{i}}} {L}_{i} ( {c}_{j} )$$

Accordingly, the one user-generated content page within the content vector that maximizes the ownership likelihood function for each browser is selected. Let popⱼ represent the global popularity of cⱼ as a percentage of all visitations in the dataset:

$${pop}_{j} = \frac{{\sum }_{k = 1}^{M} {γ}_{kj}}{{\sum }_{k = 1}^{M} {\sum }_{i = 1}^{N} {γ}_{ki}}$$

The ownership likelihood function WO can then be represented as:

Lᵢ(cⱼ)=−1*γᵢⱼ*ln(popⱼ)

This ownership likelihood function selects the one user-generated content page that is most popular to the browser after normalizing against the log popularity of the population (where popularity can be represented as a percentage). The brand proximity measure BAFS can be defined as the log ratio of the probability that a seed browser bₖ⁺ will visit content c_{b}_{ᵢ}*:

$${BAFS}_{i} = ln \frac{P ( {c}_{{b}_{i}}^{*} ∈ {c}_{bk} \vert {b}_{k}^{+} ∈ {B}^{+} )}{P ( {c}_{{b}_{i}}^{*} ∈ {c}_{bk} )}$$

In some embodiments, a brand proximity measure can be determined by calculating aggregations. In a more particular example, the aggregated log-likelihood ratio combines a binary version of Γ (rather than frequency-weighted) with an additional vector \vec{λ} of metadata representing class-condition likelihood ratios for every user-generated content page. For each user-generated content page cⱼ, let

$${λ}_{j} = ln ( \frac{P ( {c}_{{b}_{i}}^{*} ∈ {c}_{bk} \vert {b}_{k}^{+} ∈ {B}^{+} )}{P ( {c}_{{b}_{i}}^{*} ∈ {c}_{bk} )} )$$

It should be noted that, in some embodiments, the probabilities are Laplace-smoothed frequency estimates.

Using the additional vector \vec{λ}, the social variables for each candidate browser bᵢ⁰ can be calculated by aggregating over the relevant metadata. More particularly, two aggregations—the inner product and the normalized inner product—can be determined:

$${Sum LLR}_{i} = \vec{λ} \cdot {\vec{γ}}_{i}^{′} and$$

$${AveLLR}_{i} = \frac{1}{\vert {c}_{{b}_{i}} \vert} \vec{λ} \cdot {\vec{γ}}_{i}^{′}$$

It should be noted that a binary-weighted Γ can be used and the brand proximity measure determines the sum and average across the relevant metadata.

As described above, in some embodiments, brand affinity weights can be used. For each brand, a brand-affinity score can be assigned to each piece of content. The scores can be determined by creating a positive distribution (D₊) for the brand, and a corresponding baseline distribution (D₀) for browsers in general. D₊ includes the seed nodes and all content that those seed nodes have visited (i.e., the Content Landscape). D₀ represents a set of randomly selected browser nodes and its associated content. D₊ and D₀ are the brand-conditional and unconditional, respectively, distributions of content visitation.

More particularly, D₀ can be estimated by summing up, across the set of all browsers (B), the number of browsers that visit each content piece, cᵢ, and then normalizing by the total number of visits. Similarly, D₊ can be estimated by summing up and normalizing across the set of positive browsers (e.g., browsers observed to have brand affinity based on visiting a brand page, browsers that are prior clickers, browsers that are prior converts, or browsers selected using any other suitable criteria). It should be noted that the elements of D₊ and D₀ represent the conditional likelihood of an (observed) visit to a particular content piece by a positive (seed node) and baseline (respectively) browser. Specifically, D₊[cᵢ]=p(cᵢ|+) and D₀[cᵢ]=p(cᵢ).

The final brand-affinity weighting of a given piece of content contained within the Content Landscape can be defined by the logarithm of the quotient of D₊[cᵢ] and D₀[cᵢ]. It should be noted that a piece of content within the Content Landscape has positive, negative, or neutral brand affinity. The derived weights compare the likelihood of visiting content by brand actors (or seed nodes) against that of a randomly-selected browser. That is, if a disproportionate number of brand actors have an affinity with a certain piece of content, then that piece of content is a good identifier for future potential brand actors. The logarithm is taken to recalibrate the scores, such that positive, negative and neutral brand affinity scores fall in the positive, negative and zero areas of the real number line, respectively.

For example, in some embodiments, a naïve Bayes approach can be used, which assumes that the likelihoods of visiting different content pieces are independent. Each network neighbor of the seed nodes is evaluated by looking at the content that it has visited that is also in the Content Landscape. Using the naïve Bayes assumption, a browser brand affinity score is assigned by summing the weights associated with the intersection of the set of content that the browser has visited and the content in the Content Landscape. Once summed, each browser in the micro-affinity group has a unique brand affinity score that can be used to create an ordered set of browsers within the group.

Alternatively, statistical learning can be used to further enhance the ranking system. For example, the browser ranking system can be enhanced by further summarizing the structure of the network. The ranking goal is the same, but the input to the ranking function is the entire network rather than just the browser's content vector:

Rankₖ(bⱼ)=f(BCⱼₖ)

It should be noted that the index (k) is not the original content-affinity network, but represents the content-affinity network in block form, where the upper block represents the part of the network that is the Content Landscape. The ranking system summarizes the structure and relationships between the browser in question and the Content Landscape part of the network.

Alternatively, any other suitable brand proximity measure can be calculated.

These proximity measures (e.g., MBAL, BAFSᵢ, and each of PosLink, SumLLRᵢ, and AveLLRᵢ) can be used to create social variables for inclusion in brand proximity. In a more particular example, the brand proximity vector \vec{φ_{b}_{ᵢ}}, can include MBAL, BAFSᵢ, and each of PosLink, SumLLRᵢ, and AveLLRᵢ, which are computed over three different collections of user-generated content pages—all user-generated content, micro-user-generated content, and macro-user-generated content.

It should be noted that, although the embodiments described herein generate social variables for creating a ranking score for each browser, this is merely illustrative. In some embodiments, non-social variables can also be included in the determination of the brand proximity vector \vec{φ_{b}_{ᵢ}}. In a more particular example, non-social variables can include technographic variables. Technographic variables can be variables based on what is observable by an advertisement network at the time of the impression. Examples of technographic variables are shown in the following table.

| Technographic Variable | Condition |
|---|---|
| ORG | IP Lookup - if the top level domain is .org |
| EDU | IP Lookup - if the top level domain is .edu |
| BIZ | IP Lookup - if the top level domain is .biz |
| GOV | IP Lookup - if the top level domain is .gov |
| MIL | IP Lookup - if the top level domain is .mil |
| DIALUP_SPEED | IP Lookup - if the Internet connection is dialup |
| CABLEDSL_SPEED | IP Lookup - if the Internet connection is consumer cable or DSL |
| CORPORATE_SPEED | IP Lookup - if the Internet connection is a corporate connection (T1) |
| UNKNOWN_SPEED | IP Lookup - if the Internet connection is unknown |
| MSIE_8 | User-agent header - the web browser is Microsoft Internet Explorer 8 |
| MSIE_7 | User-agent header - the web browser is Microsoft Internet Explorer 7 |
| MSIE_6 | User-agent header - the web browser is Microsoft Internet Explorer 6 |
| MSIE_OTHER | User-agent header - the web browser is Microsoft Internet Explorer, |
| | but not versions 6, 7, or 8 |
| FIREFOX | User-agent header - the web browser is any version of Mozilla |
| | Firefox |
| SAFARI | Parsed from the HTTP user-agent header - the web browser is any |
| | version of Safari |
| OPERA | User-agent header - the web browser is any version of Opera |
| CHROME | User-agent header - the web browser is any version of Google |
| | Chrome |
| WIN_7 | User-agent header - operating system is Windows 7 |
| WIN_VISTA | User-agent header - operating system is Windows Vista |
| WIN_XP | User-agent header - operating system is Windows XP |
| WIN_OTHER | User-agent header - operating system is some other Windows variant |
| MAC | User-agent header - operating system is Macintosh |
| LINUX | User-agent header - operating system is Linux |

It should be noted that these technographic variables can be based on, for example, IP lookups (e.g., using GeoIP tables, where IP addresses are not stored) or parsing the browser's user-agent header.

Alternatively or additionally, non-social variables can also include behavioral variables. Behavioral variables can be variables based on what has been observed about the behavior of a browser by a cookie-based advertisement network. Examples of behavioral variables are shown in the following table.

| Behavioral Variable | Condition |
|---|---|
| NUM_CHECKINS | Total number of times the ad network systems have seen the |
| | browser, both while advertising, and while building content |
| | affinity graph |
| NUM_CHECKINS_PER_DAY | NUM_CHECKINS divided by BROWSER_DAYS_OLD |
| UNIQ_CONTENT_LINKS | Number of distinct user-generated content pages associated |
| | with the browser |
| BROWSER_DAYS_OLD | Number of calendar days since the browser was first seen on |
| | the ad network system |

Referring back to FIG. 1, the brand proximity vector \vec{φ_{b}_{ᵢ}} can be used as the basis for selecting the brand audience of interest A at 112. More particularly, non-seed or candidate nodes bᵢ can be ranked based at least in part on some monotonic function of the projection of \vec{φ_{b}_{ᵢ}} onto one of the proximity dimensions such that:

score(bᵢ)=fᵢ(\vec{φ_{b}_{ᵢ}}·\vec{I_{q}})

It should be noted that \vec{I_{q}}=[0, . . . , 1, . . . , 0]′ is a selection vector with 1 on its qth row and fᵢ is a monotonic function to map the single proximity measure selected by \vec{I_{q}} to a ranking score for bᵢ. The brand audience of interest A includes the top-ranked browsers in B⁰ (e.g., top ten, top five, greater than a particular ranking score, etc.).

For example, in a multivariate case, rank of a browser from a set of candidate nodes can be calculated using a logistic function (MLE logistic regression) based on a linear combination of entries in its proximity measure vector:

$$rank ( {b}_{i} ) = \frac{exp ( {\sum }_{p = 1}^{P} {ω}_{p} {φ}_{{b}_{i}}^{p} )}{1 + exp ( {\sum }_{p = 1}^{P} {ω}_{p} {φ}_{{b}_{i}}^{p} )}$$

where ωₚ are weights, and each of the phi functions represents a network proximity measurement.

These scores can be used to rank the members of the micro-affinity network in order of decreasing likelihood to show brand affinity (or likelihood towards eventual entry into the same class as the set of seed nodes). Accordingly, instead of ranking content, ranking scores can be used to rank browsers in a way that the order of the ranking represents a monotonically decreasing likelihood for the browser to take a specific action in the future.

It should be noted that the above-mentioned mechanisms measure brand-affinity density and not responses (e.g., lift, conversion, etc.). When it comes to conversion prediction, conversions are generally too scarce to use for training effective targeting models. This can be because it is early in an advertising campaign, because conversion information is not recorded or shared with an advertisement network partner (pay for ad impressions at a certain cost per thousand impressions), because conversions occur off-line, and/or because conversions are rare. For example, considering that a vacation is a big ticket item that receives substantial consideration, comparison, and often off-line purchase, there are likely to be few conversions that are difficult to associate with an ad impression. In addition, a consumer may make the final conversion with a different browser.

In accordance with some embodiments, privacy-sensitive methods, systems, and media can be used for conversion prediction. For example, to initiate and optimize a marketing campaign, the above-mentioned brand affinity modeling approach can be used to train conversion models based on site vitiation and augmented with a statistical learning approach on actual conversion event data. The marketing campaign can be created with a targeted audience optimized for conversions and further optimized, by using a statistical learning approach, based on direct response feedback.

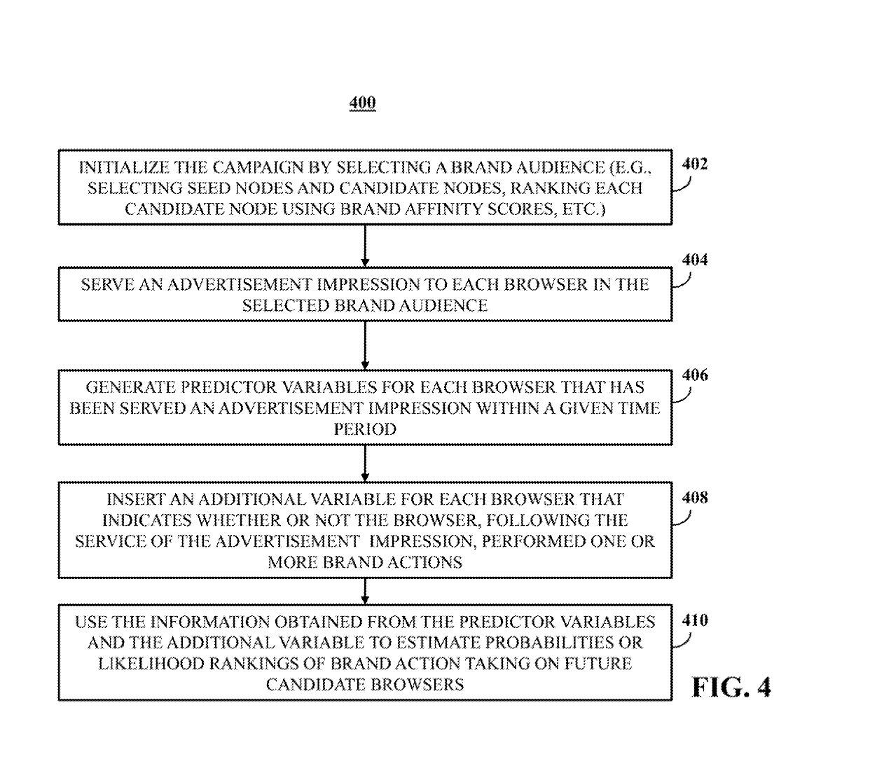

FIG. 4 illustrates a process for conversion prediction using social variables in accordance with some embodiments of the disclosed subject matter. As shown, the process 400 begins with initializing the campaign by selecting a brand audience at 402. As described above, campaign initialization starts with the selection of multiple seed nodes, where the seed nodes are generally defined as browsers that have taken a specified brand action (e.g., visiting a home page or purchasing online). However, it should be noted that the seed nodes can be any suitable browser that meets a predefined set of properties (e.g., defined by an advertiser or any other suitable user). With seed nodes identified, the subset of candidate browsers can be selected. For example, candidate nodes that are two links away from any seed browser in the bipartite affinity graph can be selected. These browsers are sometimes referred to herein as “network neighbors” and each network neighbor is a candidate for advertising in the campaign.

It should be noted that each network neighbor has the property that it has at least one piece of content in common with a seed node.

As also described above, each of the network neighbors can be ranked based on a determined ranking score. The advertising campaign can then be initialized by targeting the selected network neighbors having a ranking score greater than a desired threshold (e.g., top ten, top twenty percent, etc.). At 404, each browser in the selected brand audience or the selected network neighbors having a ranking score greater than a desired threshold can be served an advertisement impression.

In some embodiments, the selected network neighbors or candidate nodes can be optimized. For example, the optimization of the initial targets can be based on the likelihood to show organic brand affinity, where brand affinity is defined as any measureable brand interaction that is considered by a user (e.g., purchase, download, site visit, etc.). In particular, the social variables described above can also be used to predict conversions—e.g., clicks, site visitations, and/or purchases induced by an advertisement.

In a more particular example, the browser-content affinity network derived variables can be used to predict multiple event responses following an advertisement impression. A target event can be an ad click-through, a click-through to purchase, a visit to a designated web property (e.g., a particular home page or a post-purchase thank you page). It should be noted that some of the target events require direct interaction with the advertisement, while others include post-view events that follow an advertisement impression.

At 406, the prediction of post impression events can be done by creating a vector of predictor variables for each browser that has been served an ad impression within a given time period. Each browser can be described by its vector \vec{φⱼ}=[φⱼ¹, φⱼ², φⱼ³, . . . , φⱼ^{P}], where each φⱼ^{P} is a function describing structural and/or relationship information of the browser within the browser-content affinity network (e.g., Content Landscape, MATL, POSCNT, etc.), and the index (j) represents the specific set of seed nodes (usually referencing a specific client) that represent desired brand actions. It should be noted that, for a given browser, each function φⱼⁱ is computed the same, though different seed nodes will produce different values. Thus, a browser is expected to have a unique vector for each set of seed nodes.

At 408, an additional variable is added to this vector representation of each browser, wherein the variable indicates whether or not the browser, following an ad impression, performed one or more brand actions. With this information, one of various statistical learning techniques can be applied to estimate the probabilities or likelihood rankings of action taking on future candidate browsers at 410. For example, a MLE logistic regression can be used.

It should be noted that site visitation provides a good proxy for conversions and can be gathered in greater quantity, thereby allowing better targeting for campaigns with no or few conversions.

Alternatively or additionally to creating brand audiences and predicting conversions, predictive modeling holdout mechanisms for evaluating online brand advertising audiences can also be provided. For example, these mechanisms can evaluate whether a good brand audience for a brand has been identified by comparing the density of brand actors in an identified subset of the population against the density of brand actors in the population as a whole (or those identified by an alternative technique). That is, if the audience has a higher density of brand actors, then the non-actors in the audience (the vast majority) will be better candidates for brand advertising. It should be noted that a better model identifies a subset of the population with a higher density of known good prospects (e.g., action takers). Accordingly, a subpopulation of similar consumers that has a higher density of known good prospects also is likely to have a higher density of unknown good prospects. For example, a user A was a good prospect for Apple iPhone advertising, even though user A never visited the iPhone site. However, user A's network neighbors may have visited the site (e.g., since many people user A knows have iPhones).

Generally speaking, the framework for brand affinity modeling has notable differences from response-based evaluation of advertising effectiveness, such as: responses are not measured, and prospect density or brand-affinity density is measured. This can be done by taking the training/testing framework developed for response evaluation, and replacing response with a measure of brand affinity, such as (future) action taking.

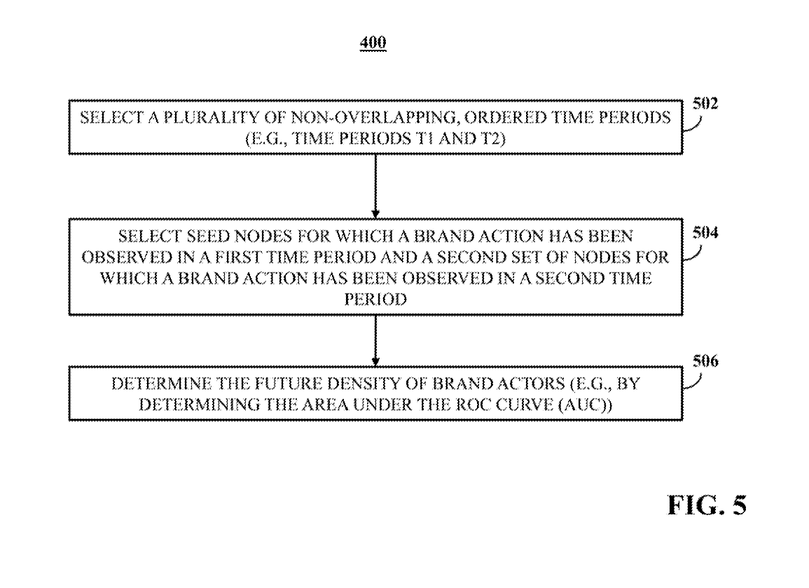

A process for evaluating or assessing brand audiences in accordance with some embodiments of the disclosed subject matter is illustrated in FIG. 5. As shown, non-overlapping, ordered time periods (e.g., times t₁ and t₂) can be selected at 502. For example, a particular time can be defined, where browser actions before the particular time can be used for training and browser actions after the particular time cannot be used in any way in building, tweaking, and/or selecting models. The training period can be defined as a window of time before the particular time and the testing period can be defined as a window of time after the particular time.

As described previously, the total set of browsers under consideration, B, is the set of all browsers known in time t₁. The seed nodes, B₁⁺, are those elements of B for which a brand action is observed in time t₁ and the future brand actors, B₂⁺, are those elements of B that are observed to take a brand action in t₂. It should be noted that times t₁ and t₂ are continuous yet disjoint time periods. It should also be noted that information in the holdout set is not used in building the audience.

To evaluate brand audience A, the future density of brand actors can determined at 506. For example, this density can be represented as:

$$\frac{\vert A ⋂ {B}_{2}^{+} \vert}{\vert A \vert}$$

Accordingly, audiences can be compared based on their future brand actor densities.

It should be noted that evaluating brand audiences based on the density of brand actors can be done with or without the serving of advertisements. To advertisers, a large proportion of an audience that shows brand affinity (e.g., action taking) without advertising can be highly indicative that the audience is a good audience for brand advertising. That is, these mechanisms are interested in brand affinity even in the absence of a driving advertisement. For example, consider a framework of “A/B/C testing” for a particular brand-affinity model M. A comparison can be made between (A) non-targeted advertising (e.g., run-of-network, RON), (B) targeting with M but without a brand-specific creative (e.g., a Red Cross public service announcement), and (C) targeting with M and with a brand-specific creative. In some embodiments, one of the keys to brand-affinity targeting can be to show a difference between (A) and (B), in terms of brand actions. While additional lift may be obtained in (C), response is being measured. However, the lift between (A) and (B) is significant. For example, the viewers of Jacques Pepin's cooking show are more likely than the general population to visit the website “cookingstuff.com.” However, that does not mean cookingstuff.com should not advertise on Jacques Pepin's cooking show. Moreover, these viewers may not visit the website in the next 48 hours and purchase something there.

Accordingly, two different brand affinity indices can be created: (1) for a subpopulation, the density of brand action-takers in the subpopulation, which would be in the interval [0,1]; and (ii) for a model, the area under the brand-affinity curve, which once the curve is normalized should be approximately in the interval [0.5,1], but could be resealed. An alternative for a subpopulation would be to define the brand-affinity index based on brand affinity lift (e.g., how much more dense is a chosen subpopulation than a baseline alternative).

More particularly, evaluation and comparison can be performed based on any suitable measure of density of a binary attribute over a set of data. In this particular example, the evaluation and comparison determines how well the different proximity measures rank the candidate nodes. Presumably, a particular campaign targets some upper portion of the ranking depending on, for example, the advertising budget and other considerations. Evaluation can be performed using receiver operating characteristic (ROC) analysis. In particular, the area under the ROC curve (AUC) can be determined to measure how well a scoring system can rank members of one class above the other. It should be noted that a higher AUC means that an audience selected from the top of the ranking has a higher density of brand actors. It should also be noted that the largest high-quality audience for selection is the network neighbor audience for a brand (N) and each selected audience can be a subset of N (e.g., the only browsers with non-zero brand proximity).

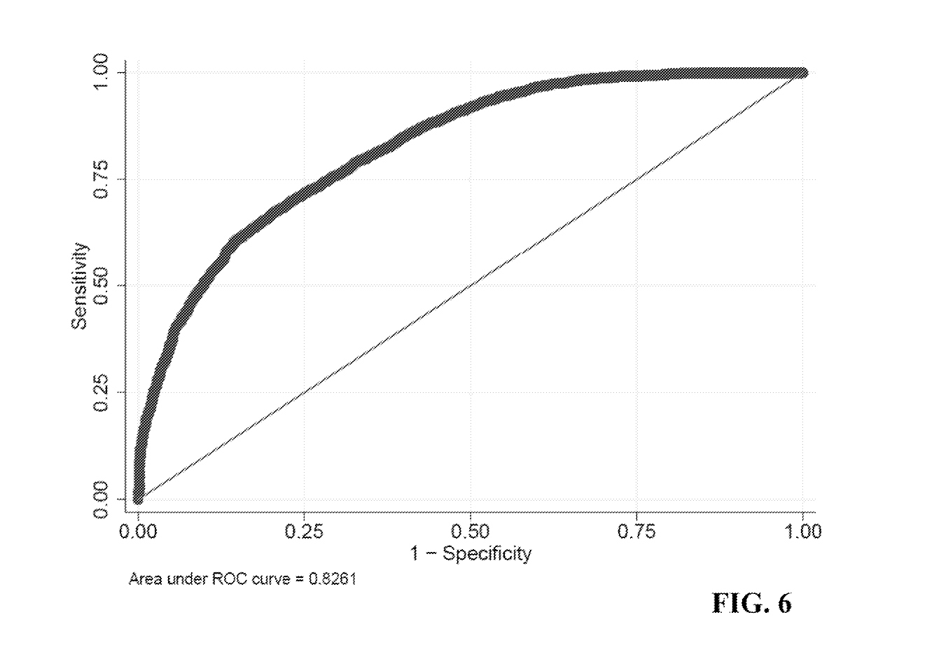

An illustrative example of a ROC curve is shown in FIG. 6. The ROC curve of FIG. 6, which is determined over the network neighbor audience for a brand (N) for the category Airline, shows that friends are very likely to be ranked higher than those-not-known-to-be-friends. As also shown, the top of the ranking is very dense with friends (as exhibited by the steep initial rise in the curve) and the bottom is nearly devoid of friends (as exhibited by the flatting of the curve).

In accordance with some embodiments, privacy-sensitive methods, systems, and media are provided for identifying social network relationships (e.g., friends) anonymously and without collecting or saving any data on browsers' identities or the content of the pages visited. Moreover, the extracted quasi-social network described above may embed an actual social network. As a result, an advertisement network or any other suitable entity can perform social network targeting without collecting or saving any data on browsers' identity or the content of the pages visited.

In accordance with some embodiments of the present invention, another set of network proximity metrics that targets the social links to leverage behavioral properties associated with social networks is provided. This leverages social relationships without requiring any data on the actual social relationships, thereby ensuring that personally identifying information or any other private information is not used. Such variables are defined to estimate the degree and connectedness within the social network that is embedded in the affinity network.

Much of the data collection occurs over online social networks. The nature of such data collection forces a distinction to be made between a browser and content, which on social networking sites is generally the online representation of the same browsers that are observed. It should be noted that social theory and research in social targeting suggests that targeting friends of friends produces benefits over traditional non-social targeting techniques. To leverage this, some embodiments of the present invention seek to estimate the actual social relationships that may exist between the browsers in the affinity network. This can be done by mapping a browser to a piece of content and labeling that content as being the browser's online representation. Then, some embodiments look to see what other browsers have visited these estimated authored pages to link browsers. Again, it should be noted that all browsers and content are anonymous, thereby not using personally identifying information.

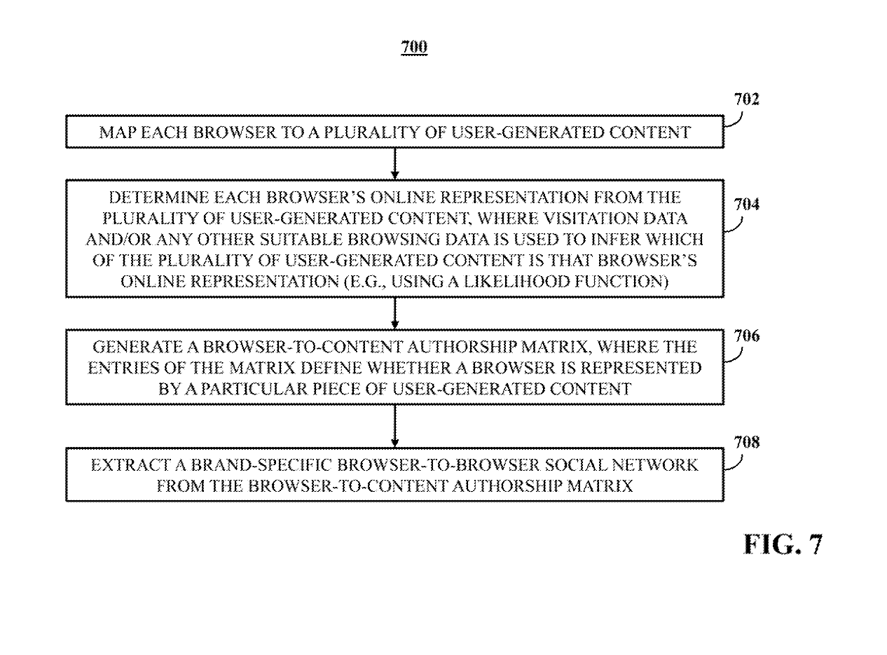

FIG. 7 is an illustrative process for estimate a quasi-social network in accordance with some embodiments of the disclosed subject matter. As shown, the process 700 begins by mapping each browser to a plurality of user-generated micro-content at 702, where visitation data and/or any other suitable browsing data is used to infer which of the plurality of user-generated micro-content is that browser's online representation at 704.

Let there be a mapping between bⱼ and cⱼ that indicates that cⱼ is the online representation of browser bⱼ.

F:CVbⱼ→bcⱼ

Here, CVbᵢ is the content vector for browser (j). Information is used to infer which of browser j's n pieces of content is most likely its online representation (or more generically, its most idiosyncratic piece of content). F can be any suitable function that selects a single piece of content amongst the browser's content.

Let L(O) be a function that represents the likelihood of a piece of content being owned by the browser. Then, the type of function can be defined as follows:

bcⱼ=arg max_{ciεCVbj}Lⱼ(cᵢ)

Accordingly, the one content within CVbⱼ that maximizes the ownership likelihood function for each browser is selected. The current implementation of Lⱼ(cᵢ) is:

Lⱼ(cᵢ)=−1*frequencyᵢⱼ*ln(popularityᵢ)

In some embodiments, the browser's online representation the one page that is most popular to the browser yet least popular to the rest of the population is selected. Alternatively, the likelihood function can change either in its inputs and/or in its functional form.

Once each browser has been mapped out to a piece of content, a browser to content authorship matrix (BCA) as an M×N matrix can be defined, where entries represent whether browser (i) is the author (or is represented by) content (j) (706 of FIG. 7). This matrix is binary with only one non-zero value per row (for example, assuming that each browser has only one online representation). Assuming that N>M (that is, more content has been observed than browsers such that each browser can have an associated piece of content), a new bipartite network by the adjacency matrix can be defined:

BSN=BC*BCA^{T}−diag(BC*BCA^{T})*I

It should be noted that the above-mentioned matrix is an M×M matrix whose rows represent the original set of browsers and whose columns represent the content associated with each browser when the index i=j. It is similar to the original matrix BC, but differs in that only associated browsers get filtered out. The first term on the right hand side of the expression indicates which browsers in row (i) visited the owned pages from browsers corresponding to the column index. The second term is the diagonal entries of the first term multiplied by an M×M identity matrix. This second term is subtracted to create an adjacency matrix, where the diagonal entries are zero. The final matrix then represents the frequency with which browser (i) visited the content associated with browser (j).

A brand-specific social network BCₜ can be created at 708, which represents a row permutation of BC such that the first R rows are the seed nodes of brand (t). If the branded permutation to BCA is applied as well, a branded browser social network can be defined as follows:

BSNₜ=BCₜ*BCAₜ^{T}−diag(BCₜ*BCAₜ^{T})*I

This matrix has the same explanation as does the one above, with the difference being that the first R rows and columns correspond to the seed nodes of brand (t). This can then be represented as a matrix in block form as:

$${BSN}_{t} = [ \begin{matrix}BSNat , at & BSNat , b \\ BSNb , at & BSNb , b\end{matrix} ]$$

Here, the submatrices are individual adjacency matrices representing the relationships between browsers of type at (seed) and type b (candidate).

BSN and BSNₜ represent the browser-to-browser inferred social networks for both unbranded and branded cases, respectively. By deriving this social network, inferences about browser behavior regarding the potential for future brand actions can be made. To do this, approaches to summarize the relationships a given non-seed browser has with the seed browsers of a given brand can be derived.

Accordingly, from this adjacency matrix, three variables can be defined:

$${NNF\_VB}_{j} = \{ \begin{matrix}0 , if {\sum }_{i = 1}^{R} BSN ( i , j ) = 0 \\ 1 , if {\sum }_{i = 1}^{R} BSN ( i , j ) > 0\end{matrix} for all j > R$$

(which looks to see if column sums are greater than zero in the indicated interval)

$${NNF\_VT}_{i} = \{ \begin{matrix}0 , if {\sum }_{j = 1}^{R} BSN ( i , j ) = 0 \\ 1 , if {\sum }_{j = 1}^{R} BSN ( i , j ) > 0\end{matrix} for all i > R$$

(which looks to see if row sums are greater than zero in the indicated interval)

$${NNF\_RE}_{i} = \{ \begin{matrix}0 , if {\sum }_{j = 1}^{R} BSN ( i , j ) * BSN ( j , i ) = 0 \\ 1 , if {\sum }_{j = 1}^{R} BSN ( i , j ) * BSN ( j , i ) > 0\end{matrix} for all i > R$$

(which looks to see if browser (i) has any reciprocal relationships with any action takers).

These three variables represent, respectively, that 1) a non-seed browser was visited by at least one seed browser, 2) a non-seed browser visited the online representation of at least one seed browser, and 3) a non-seed browser has a reciprocal relationship with at least one seed browser. These variables are another form of representing network proximity between non-seed and seed nodes and can be used alone for targeting or can be combined with other measures into a multivariate scoring model. Furthermore, these variables represent only a single way to summarize browser to browser relationships within the inferred social network. Alternatively, any other suitable measures can be used.

In accordance with some embodiments, these mechanisms for estimating browser-content links and the browser to browser social network can be used in a variety of applications.

In one example, the above-mentioned variables can be used as further evidence of network proximity. Accordingly, browsers with positive values for the variables can become candidates for advertising targeting. Further, this information can be used as evidence in machine learning type statistical models whose goal is to find subsets of candidate browsers with the highest likelihood of showing brand affinity.

In another example, these mechanisms can be used to provide cookie continuity. Two common problems in interne advertising are cookie attrition and the placement of multiple cookies across different computers representing the same browser (e.g., cookies on work and home computers). The mechanism for inferring online browser representations has the additional application of ensuring cookie continuity within the database. In both cases, the content pieces that are inferred as that of a browser j (bcᵢ) has a high likelihood of stability over time, and additionally, will be the online representation for the browser regardless of the browsing location or machine. By mapping cookies to content, these approaches can pull, for each content, the set of cookies currently and across time mapped to it. Then, the information across the cookies can be aggregated to create cookie continuity that can then be leveraged for more accurate targeting.

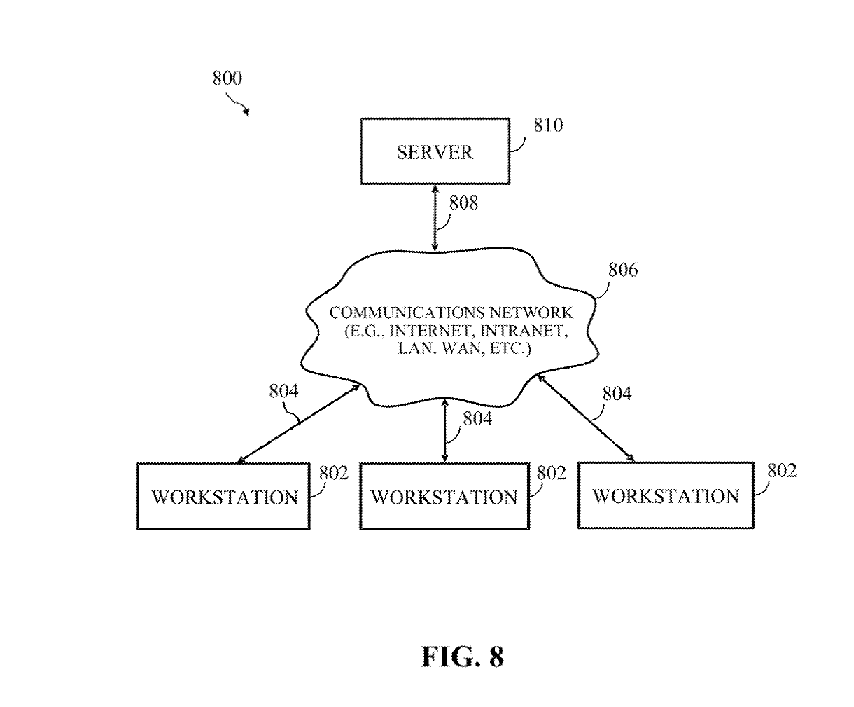

FIG. 8 is a generalized schematic diagram of a system 800 on which the application may be implemented in accordance with some embodiments of the present invention. As illustrated, system 800 may include one or more user computers 802. User computers 802 may be local to each other or remote from each other. User computers 802 are connected by one or more communications links 804 to a communications network 806 that is linked via a communications link 808 to a server 810.

System 800 may include one or more servers 810. Server 810 may be any suitable server for providing access to the application, such as a processor, a computer, a data processing device, or a combination of such devices. For example, the application can be distributed into multiple backend components and multiple frontend components or interfaces. In a more particular example, backend components, such as data collection and data distribution can be performed on one or more servers 810. Similarly, the graphical user interfaces displayed by the application, such as a data interface and an advertising network interface, can be distributed by one or more servers 810 to user computer 802.

More particularly, for example, each of the client 802 and server 810 can be any of a general purpose device such as a computer or a special purpose device such as a client, a server, etc. Any of these general or special purpose devices can include any suitable components such as a processor (which can be a microprocessor, digital signal processor, a controller, etc.), memory, communication interfaces, display controllers, input devices, etc. For example, client 802 can be implemented as a personal computer, a personal data assistant (PDA), a portable email device, a multimedia terminal, a mobile telephone, a set-top box, a television, etc.

In some embodiments, any suitable computer readable media can be used for storing instructions for performing the processes described herein, can be used as a content distribution that stores content and a payload, etc. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Referring back to FIG. 8, communications network 806 may be any suitable computer network including the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. Communications links 804 and 808 may be any communications links suitable for communicating data between user computers 802 and server 810, such as network links, dial-up links, wireless links, hard-wired links, any other suitable communications links, or a combination of such links. User computers 802 enable a user to access features of the application. User computers 802 may be personal computers, laptop computers, mainframe computers, dumb terminals, data displays, Internet browsers, personal digital assistants (“PDAs”), two-way pagers, wireless terminals, portable telephones, any other suitable access device, or any combination of such devices. User computers 802 and server 810 may be located at any suitable location. In one embodiment, user computers 802 and server 810 may be located within an organization. Alternatively, user computers 802 and server 810 may be distributed between multiple organizations.

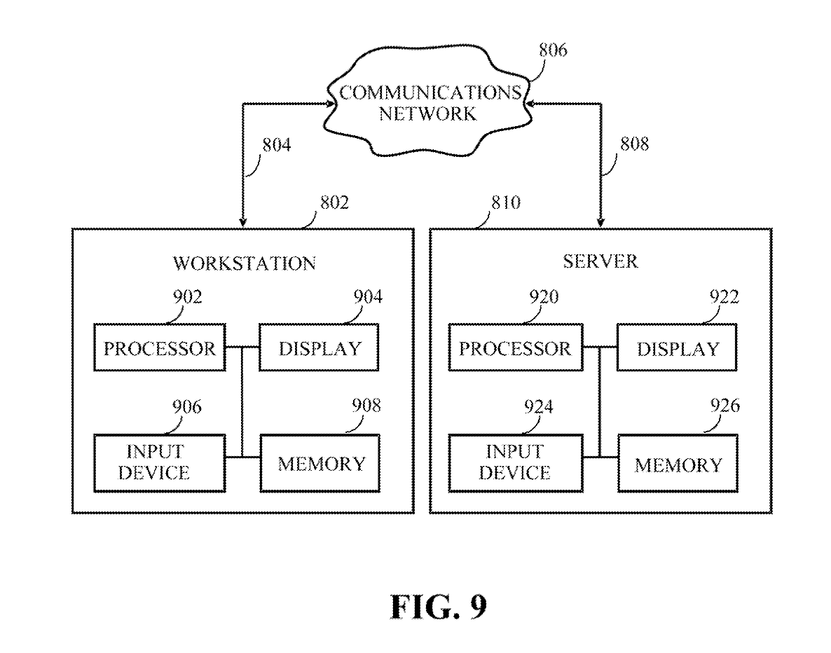

The server and one of the user computers, which are depicted in FIG. 8, are illustrated in more detail in FIG. 9. Referring to FIG. 9, user computer 802 may include processor 902, display 904, input device 906, and memory 908, which may be interconnected. In a preferred embodiment, memory 908 contains a storage device for storing a computer program for controlling processor 902.

Processor 902 uses the computer program to present on display 904 the application and the data received through communications link 804 and commands and values transmitted by a user of user computer 802. It should also be noted that data received through communications link 804 or any other communications links may be received from any suitable source. Input device 906 may be a computer keyboard, a cursor-controller, dial, switchbank, lever, or any other suitable input device as would be used by a designer of input systems or process control systems.

Server 810 may include processor 920, display 922, input device 924, and memory 926, which may be interconnected. In a preferred embodiment, memory 926 contains a storage device for storing data received through communications link 808 or through other links, and also receives commands and values transmitted by one or more users. The storage device further contains a server program for controlling processor 920.

In some embodiments, the application may include an application program interface (not shown), or alternatively, the application may be resident in the memory of user computer 802 or server 810. In another suitable embodiment, the only distribution to user computer 802 may be a graphical user interface (“GUI”) which allows a user to interact with the application resident at, for example, server 810.

In one particular embodiment, the application may include client-side software, hardware, or both. For example, the application may encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

Although the application is described herein as being implemented on a user computer and/or server, this is only illustrative. The application may be implemented on any suitable platform (e.g., a personal computer (“PC”), a mainframe computer, a dumb terminal, a data display, a two-way pager, a wireless terminal, a portable telephone, a portable computer, a palmtop computer, an H/PC, an automobile PC, a laptop computer, a cellular phone, a personal digital assistant (“PDA”), a combined cellular phone and PDA, etc.) to provide such features.

It will also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for constructing brand audiences for targeting advertisements, the method comprising:
collecting visitation data relating to user-generated micro-content from a plurality of browsers;
extracting a quasi-social network from the collected visitation data, wherein the quasi-social network comprises a plurality of links that are induced between the plurality of browsers visiting the user-generated micro-content;
selecting seed nodes from the plurality of browsers, wherein the selected seed nodes have performed a brand action relating to the user-generated micro-content that is indicative of brand affinity;
determining candidate nodes from the plurality of browsers based at least in part on a distance from the seed nodes in the quasi-social network;
calculating a brand proximity score for each of the candidate nodes, wherein the brand proximity score includes one or more brand proximity measures and wherein the brand proximity score is an aggregated distance measurement between the candidate nodes and the seed nodes;
generating a ranking of the candidate nodes based on the brand proximity score; and
selecting a brand audience for serving an advertisement based on the generated ranking.

2. The method of claim 1, further comprising associating weights with each of the plurality of link in the quasi-social network, wherein the weights indicate whether one of the browsers has visited a particular piece of user-generated micro-content.

3. The method of claim 1, further comprising generating a bipartite content affinity network graph that maps the candidate nodes and the seed nodes to user-generated micro-content.

4. The method of claim 1, wherein one of the one or more brand proximity measures calculates the number of unique user-generated content pages that link one of the nodes with one or more of the seed nodes.

5. The method of claim 1, wherein one of the one or more brand proximity measures calculates the maximum number of unique user-generated content pages that link one of the nodes with one or more of the seed nodes.

6. The method of claim 1, wherein one of the one or more brand proximity measures calculates the minimum Euclidian distance between a normalized content vector of one of the candidate nodes and the normalized content vector of any of the seed nodes.

7. The method of claim 1, wherein one of the one or more brand proximity measures calculates the maximum cosine similarity of a content vector of one of the candidate nodes and the content vector of any of the seed nodes.

8. The method of claim 1, wherein one of the one or more brand proximity measures calculates the ratio of the number of seed nodes to the number of candidate nodes.

9. The method of claim 1, wherein one of the candidate nodes generates a page of user-generated micro-content and wherein one of the one or more brand proximity measures determines whether one or more of the seed nodes has visited the page of user-generated content generated by that candidate node.

10. The method of claim 1, wherein the one or more brand proximity measures are calculated over a collection of user-generated content pages and wherein the collection of user-generated content pages comprises at least one of: all user-generated content, micro-user-generated content, and macro-user-generated content.

11. The method of claim 1, further comprising predicting conversion of the advertisements by: serving an advertisement to nodes in the brand audience; generating a prediction model for each candidate node; inserting an additional variable that indicate whether each candidate node performed one or more brand actions; and training the prediction model to estimate the likelihood of brand action by future candidate nodes.

12. The method of claim 1, further comprising evaluating the selected brand audience by comparing the density of browsers within the selected brand audience that have performed the brand action with the density of browsers within all nodes that have performed the brand action.

13. A system for generating brand audiences for targeting advertisements, the system comprising:
a processor that:
collects visitation data relating to user-generated micro-content from a plurality of browsers;
extracts a quasi-social network from the collected visitation data, wherein the quasi-social network comprises a plurality of links that are induced between the plurality of browsers visiting the user-generated micro-content;
selects seed nodes from the plurality of browsers, wherein the selected seed nodes have performed a brand action relating to the user-generated micro-content that is indicative of brand affinity;
determines candidate nodes from the plurality of browsers based at least in part on a distance from the seed nodes in the quasi-social network;
calculates a brand proximity score for each of the candidate nodes, wherein the brand proximity score includes one or more brand proximity measures and wherein the brand proximity score is an aggregated distance measurement between the candidate nodes and the seed nodes;
generates a ranking of the candidate nodes based on the brand proximity score; and
selects a brand audience for serving an advertisement based on the generated ranking.

14. The system of claim 13, wherein the processor is further configured to associate weights with each of the plurality of link in the quasi-social network, wherein the weights indicate whether one of the browsers has visited a particular piece of user-generated micro-content.

15. The system of claim 13, wherein the processor is further configured to generate a bipartite content affinity network graph that maps the candidate nodes and the seed nodes to user-generated micro-content.

16. The system of claim 13, wherein the processor is further configured to calculate the number of unique user-generated content pages that link one of the nodes with one or more of the seed nodes.

17. The system of claim 13, wherein the processor is further configured to calculate the maximum number of unique user-generated content pages that link one of the nodes with one or more of the seed nodes.

18. The system of claim 13, wherein the processor is further configured to calculate the minimum Euclidian distance between a normalized content vector of one of the candidate nodes and the normalized content vector of any of the seed nodes.

19. The system of claim 13, wherein the processor is further configured to calculate the maximum cosine similarity of a content vector of one of the candidate nodes and the content vector of any of the seed nodes.

20. The system of claim 13, wherein the processor is further configured to calculate the ratio of the number of seed nodes to the number of candidate nodes.

21. The system of claim 13, wherein one of the candidate nodes generates a page of user-generated micro-content and wherein the processor is further configured to determine whether one or more of the seed nodes has visited the page of user-generated content generated by that candidate node.

22. The system of claim 13, wherein the processor is further configured to calculate the one or more brand proximity measures over a collection of user-generated content pages and wherein the collection of user-generated content pages comprises at least one of: all user-generated content, micro-user-generated content, and macro-user-generated content.

23. The system of claim 13, wherein the processor is further configured to predict conversion of the advertisements by: serving an advertisement to nodes in the brand audience; generating a prediction model for each candidate node; inserting an additional variable that indicate whether each candidate node performed one or more brand actions; and training the prediction model to estimate the likelihood of brand action by future candidate nodes.

24. The system of claim 13, wherein the processor is further configured to evaluate the selected brand audience by comparing the density of browsers within the selected brand audience that have performed the brand action with the density of browsers within all nodes that have performed the brand action.

25. A non-transitory computer-readable medium containing computer-executable instructions that, when executed by a processor, cause the processor to perform a method for constructing brand audiences for targeting advertisements, the method comprising:
collecting visitation data relating to user-generated micro-content from a plurality of browsers;
extracting a quasi-social network from the collected visitation data, wherein the quasi-social network comprises a plurality of links that are induced between the plurality of browsers visiting the user-generated micro-content;
selecting seed nodes from the plurality of browsers, wherein the selected seed nodes have performed a brand action relating to the user-generated micro-content that is indicative of brand affinity;
determining candidate nodes from the plurality of browsers based at least in part on a distance from the seed nodes in the quasi-social network;
calculating a brand proximity score for each of the candidate nodes, wherein the brand proximity score includes one or more brand proximity measures and wherein the brand proximity score is an aggregated distance measurement between the candidate nodes and the seed nodes;
generating a ranking of the candidate nodes based on the brand proximity score; and
selecting a brand audience for serving an advertisement based on the generated ranking.

26. The non-transitory computer-readable medium of claim 25, wherein the method further comprises associating weights with each of the plurality of link in the quasi-social network, wherein the weights indicate whether one of the browsers has visited a particular piece of user-generated micro-content.

27. The non-transitory computer-readable medium of claim 25, wherein the method further comprises generating a bipartite content affinity network graph that maps the candidate nodes and the seed nodes to user-generated micro-content.

28. The non-transitory computer-readable medium of claim 25, wherein one of the one or more brand proximity measures calculates the number of unique user-generated content pages that link one of the nodes with one or more of the seed nodes.

29. The non-transitory computer-readable medium of claim 25, wherein one of the one or more brand proximity measures calculates the maximum number of unique user-generated content pages that link one of the nodes with one or more of the seed nodes.

30. The non-transitory computer-readable medium of claim 25, wherein one of the one or more brand proximity measures calculates the minimum Euclidian distance between a normalized content vector of one of the candidate nodes and the normalized content vector of any of the seed nodes.

31. The non-transitory computer-readable medium of claim 25, wherein one of the one or more brand proximity measures calculates the maximum cosine similarity of a content vector of one of the candidate nodes and the content vector of any of the seed nodes.

32. The non-transitory computer-readable medium of claim 25, wherein one of the one or more brand proximity measures calculates the ratio of the number of seed nodes to the number of candidate nodes.

33. The non-transitory computer-readable medium of claim 25, wherein one of the candidate nodes generates a page of user-generated micro-content and wherein one of the one or more brand proximity measures determines whether one or more of the seed nodes has visited the page of user-generated content generated by that candidate node.

34. The non-transitory computer-readable medium of claim 25, wherein the one or more brand proximity measures are calculated over a collection of user-generated content pages and wherein the collection of user-generated content pages comprises at least one of all user-generated content, micro-user-generated content, and macro-user-generated content.

35. The non-transitory computer-readable medium of claim 25, wherein the method further comprises predicting conversion of the advertisements by: serving an advertisement to nodes in the brand audience; generating a prediction model for each candidate node; inserting an additional variable that indicate whether each candidate node performed one or more brand actions; and training the prediction model to estimate the likelihood of brand action by future candidate nodes.

36. The non-transitory computer-readable medium of claim 25, wherein the method further comprises evaluating the selected brand audience by comparing the density of browsers within the selected brand audience that have performed the brand action with the density of browsers within all nodes that have performed the brand action.
